(19) United States
(12) Patent Application Publication
(10) Pub. No.: US 2010/0282924 A1
(43) Pub. Date: Nov. 11, 2010

(54) Mobile Device Stand for Restaurants and Bars

(76) Inventor: David Brinson Boies, Austin, TX (US)

Correspondence Address: MATTHEW E. BURR, 620 CONGRESS AVENUE, STE 320, AUSTIN, TX, 78701, US

(21) Appl. No.: 12/776,521

(22) Filed: May 10, 2010

Related U.S. Application Data
(60) Provisional application No. 61/177,036, filed on May 11, 2009.

(51) Int. Cl. F16M 11/22; F16M 11/02; G09F 7/00; G09F 13/00

(52) U.S. Cl. 248/163.1; 248/176.1; 40/584; 40/541

(57) ABSTRACT

A stand for a mobile device such as a cell phone or MP3 music player provides an A-frame support structure having a width sufficient to support the device, a front leg, a back leg and a top and bottom. A shelf projects out at approximately a right angle from the bottom front of the A-frame support for a distance sufficient to support the device. A device resting on the lip is lifted away from the surface of a table or bar and protected from fluid or detritus.

### CROSS-REFERENCE TO RELATED APPLICATIONS

This application is related to, claims priority from and the benefit of provisional patent application Ser. No. 61/177,036, entitled Mobile Device Stand for Restaurants and Bars, filed May 11, 2009, by the same inventor, the disclosure of which is incorporated herein by reference.

### TECHNICAL FIELD

This invention relates generally to display or protective stands and more particularly to a table or countertop stand for cell phones or other mobile devices to keep such devices dry but visible on the table of a restaurant or the counter of a bar.

### BACKGROUND

Miniaturized technology and software to operate such technology has lead to the proliferation of portable mobile devices such as cell phones, email devices like the Blackberry®, music players and multifunctional devices such as the iPhone®. The power of such devices has grown to where many people always have their device with them at all times for performing a wide variety of tasks.

Naturally, therefore, people bring their device into restaurants and bars. When one brings their device into a restaurant or bar, a problem immediately becomes apparent: where to keep the device while one is eating or drinking. Generally, one is sitting in such an establishment. For men especially, keeping the device in a pants pocket, while safe, can nevertheless make it difficult to retrieve the device for use, because it can be awkward to retrieve a device from a pants pocket while sitting. Furthermore, keeping the device in one's clothing such as a jacket pocket, or even a purse, muffles the alert sound of the device and may result in missed calls or other messages such as text messages or instant messages.

Keeping the device on the restaurant table or bar counter allows easy access and allows the added benefit of being able to see the device's display screen so that one can see whether a call or message is coming in, even if one cannot hear the alert tone. Putting the device on the table or counter surface, however, is problematic, not the least because such surfaces tend to be or to become wet. There is also the risk that food or drink will be spilled on the device.

Although the bar and restaurant industry is familiar with a great variety of table top display stands and the like, there nevertheless remains an unmet need for an inexpensive, simple apparatus that will allow a patron to keep a mobile device out in view but safe from the hazards of the establishment.

### SUMMARY

The present disclosure describes a stand for a mobile device. The stand provides an A-frame support structure having a width sufficient to support the device, a front, a back and a top and bottom. A lip projects out at approximately a right angle from the bottom front of the A-frame support for a distance sufficient to support the device. Alternative embodiments provide a double-wide version which supports two or more devices side by side. Additional alternative embodiments provide support lips that project from the both the front and the back of the stand. Still further alternative embodiments provide a surface to display advertising or other information, and a charging unit, or a port for a charging unit, is provided in certain embodiments to connect a device to a source of electricity for charging the battery of the device.

### BRIEF DESCRIPTION OF THE DRAWINGS

For a more complete understanding of the present disclosure, and the advantages thereof, reference is now made to the following description taken in conjunction with the accompanying drawings, in which:

FIG. 1 is an isometric diagrammatic illustration an exemplary embodiment of an apparatus of the present disclosure.

FIG. 2 is an isometric diagrammatic illustration an exemplary alternative embodiment of an apparatus of the present disclosure.

### DETAILED DESCRIPTION

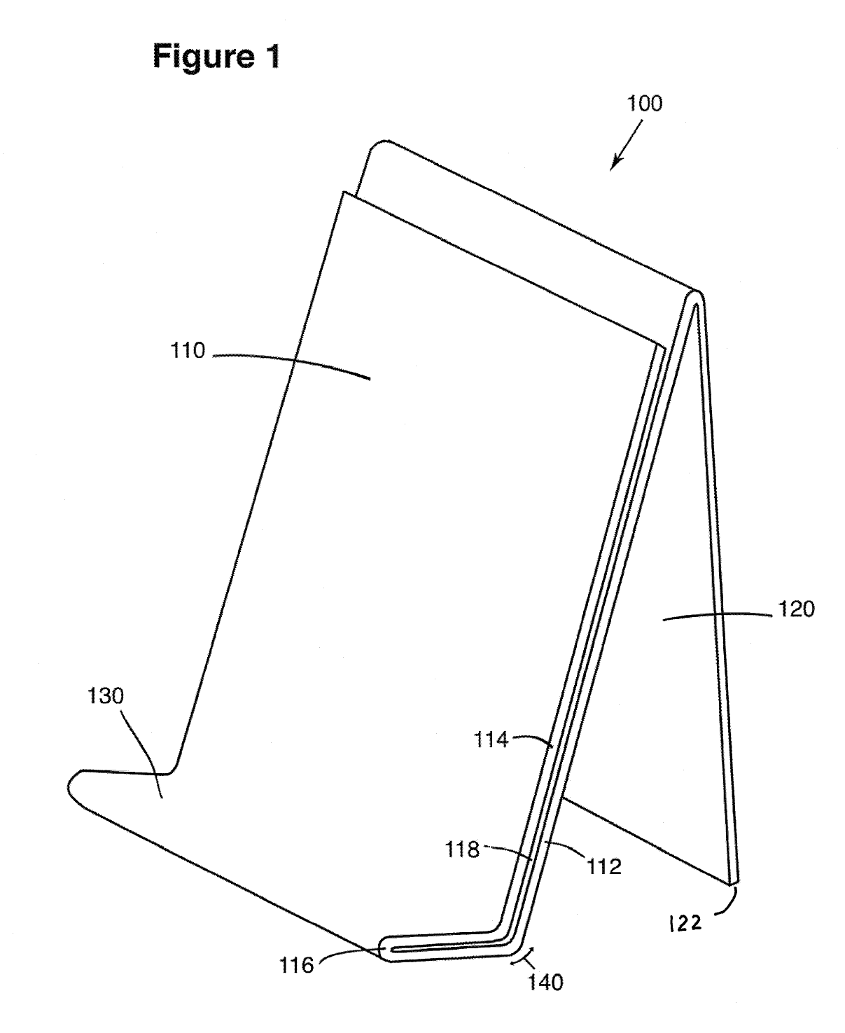

FIG. 1 is an isometric diagrammatic illustration an exemplary embodiment of an apparatus of the present disclosure. Referring to FIG. 1 of the drawings, the reference numeral 100 generally designates a device stand embodying features of the present disclosure. Table stand 100 provides an A-frame design having front surface 110 and back surface 120. Lip or shelf 130 extends forward substantially at a right angle from the bottom of front 110 to create angle 140 between lip 130 and a flat supporting surface such as a table top (not shown). Lip 130 extends away from surface 110 for a sufficient distance to provide support for a mobile device.

Front leg or surface 110 may be formed in a unitary piece by hairpin bend 116 yielding secondary front surface 112 and primary see-through front surface 114 separated by gap 118. In contrast, back surface 120 supports stand 100 at block terminus 122. Gap 118 provides a space and support for one or more printed insert such as advertising, menu items, and specials.

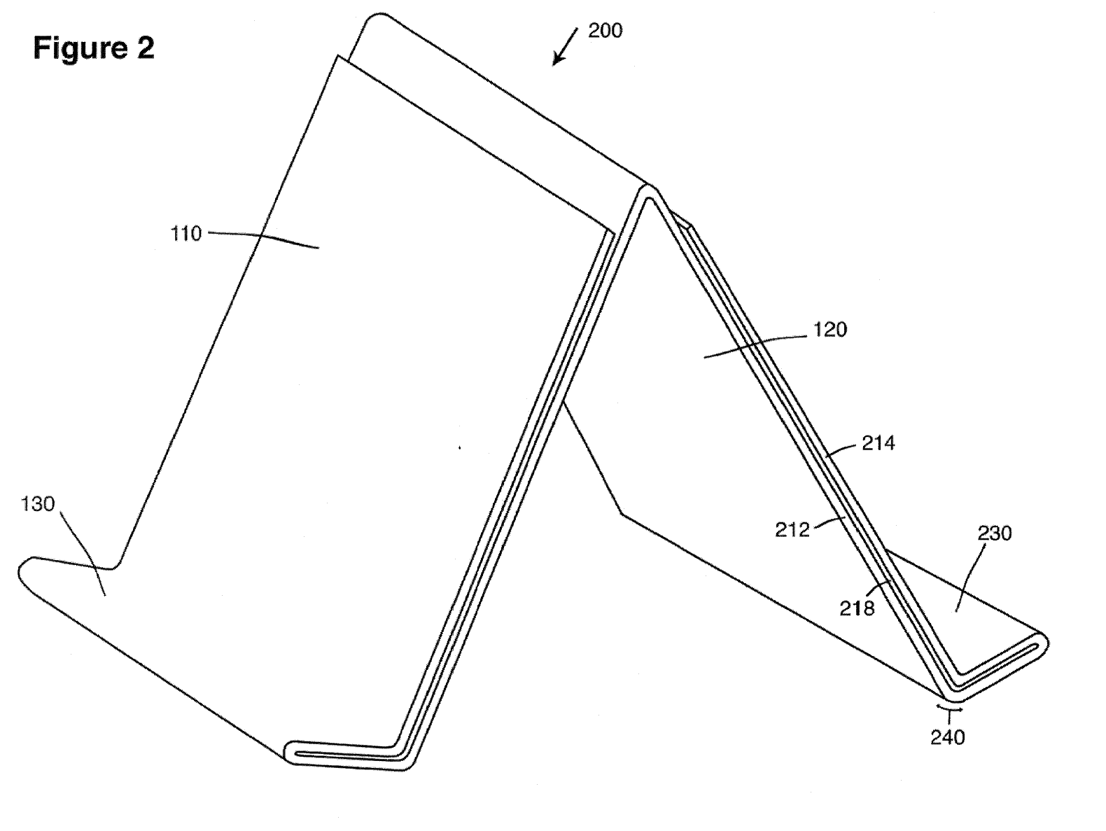

FIG. 2 is an isometric diagrammatic illustration an exemplary alternative embodiment of an apparatus of the present disclosure. The reference numeral 200 generally designates a device stand embodying features of the alternative embodiment. In contrast to the embodiment of FIG. 1, this alternative embodiment duplicates the lip structure of front lip 130 at back surface 120. Instead of block terminus 122, the embodiment of FIG. 2 provides back lip 230 extending from the bottom of surface or leg 120, at substantially a right angle, for a distance sufficient to support a mobile device. Lip 230 form angle 240 between lip 230 and the surface of the table or counter (not shown) on which stand 200 rests. Primary see-through back surface 214 and secondary back surface 212 are formed by folding surface 120 and create gap 218 which may house one or more insert.

Lips or shelves 130 and 230 extend out from surfaces 110 and 120, respectively, for a distance sufficient to support a mobile device such as a cell phone. Angle 140 and 240 of lips 130 and 230 lift the device off of whatever surface stand 100 or 200 is resting on, such as a table top, thereby removing the device a little bit further from any hazards such as pooled liquid that might be on the table top. The angular design of stands 100 and 200 has the advantage of presenting the display screen of the mobile device at an angle that enhances viewing of the display by the user.

Alternative embodiments provide a table stand support structure that is substantially perpendicular to the table top and which provide a shelf or lip that projects from approximately a midpoint of the of the support structure substantially perpendicular to the stand support and parallel to the table top. Yet other alternative embodiments provide a support structure that is substantially perpendicular to the table and wherein the shelf projects from the bottom of the support at an upward angle.

A device stand of the present disclosure may be fabricated from a wide variety of materials. Clear plastic or acrylic have the advantage of being easily formable into a unitary piece at low cost, and have the extra advantage of being transparent for the display of information on an insert in gap 118/218 and so forth. Plastic and acrylic are also durable for the rough and tumble abuse the stands may have to endure in a commercial environment. Despite the advantages of plastic or acrylic, a stand of the present disclosure may be constructed from almost anything such as glass, wood, metal, polymer, or any suitable material.

The unitary structure illustrated here has the advantage of simplicity and low cost. The present disclosure contemplates, however, that decorative embodiments may have more components, colors, or decorative embellishments so as to fit in with the décor of a particular establishment. The present disclosure, therefore, is not limited solely to unitary constructions of the stand described herein.

In particular, specific high-end embodiments provide a power-source such as a battery or a device port with an electrical cord that can be plugged into any convenient wall socket. Such a power source maybe mounted on the stand by any suitable means such as adhesive, screws, Velcro®, and so forth, and specific embodiments may provide a housing for the power source. In certain embodiments, the power source connects to an ac/dc converter useful for charging the battery of the device that is plugged into it. Such powered embodiments may provide a powered display for advertising or other information on front surface 110, such as may be accomplished with an LED display on surface 110.

Alternative embodiments may provide additional features. For example, some alternative embodiments may provide one or more port or hole through which a power cord or earphone cord and the like may be threaded so that the device maybe charging or the user can listen while the device sits on the stand. Another feature of specific alternative embodiments is non-skid surfaces where the stand contacts the table top or other surface. Other alternative embodiments provide a double-wide version in which two devices fit sit by side.

In operation, a stand of the present disclosure rests on the top of a table or bar or the like. An insert may or not be present in gap 118. A Patron sits at the table or bar and places their mobile device on lip 130, 230. The device is thereby safely removed from the table top and protected from liquid or detritus on the table. Additionally, the patron is able to see the display of the device because the device is angled so as to reduce glare from ambient light in the establishment. Being able to see the device display is advantageous in environments, such as a loud bar with live music where it is difficult to hear an alert tone. Should the patron wish to use the device, it is easily retrieved without having to dig through a pants pocket or a purse.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A table stand for a mobile device, the stand comprising:
A support structure to support a device;
the support structure having a front, a back a top and a bottom; and
one or more shelf that projects from the support structure for a distance sufficient to support the device whereby the shelf is at least partially raised off of the table.

2. A table stand for a mobile device, the stand comprising:
an A-frame support structure having a front, a back a top and a bottom;
one or more shelf that projects from the bottom of the support structure at approximately a right angle for a distance sufficient to support the device.

3. The table stand of claim 2, wherein at least one shelf projects from the bottom front of the support structure at approximately a right angle for a distance sufficient to support the device, wherein at least one shelf is formed in a unitary piece by a hairpin bend that yields a secondary surface and a primary see-through surface such that the primary and secondary surfaces are separated by a gap.

4. The table stand of claim 3, further comprising an information display disposed in the gap.

5. The table stand of claim 2, further comprising a surface upon which to display information.

6. The table stand of claim 2, wherein a first shelf projects from the bottom front of the support structure at approximately a right angle for distance sufficient to support a device, and a second shelf projects from the bottom back of the support structure at approximately a right angle for distance sufficient to support a device.

7. The table stand of claim 2, further comprising a width, wherein the width is sufficient to support two devices side by side.

8. The table stand of claim 2, further comprising a device port connectable to a source of electricity.

9. The table stand of claim 2, where in the front of the stand further comprises a primary see-through front surface and secondary front surface, the primary and secondary front surfaces being separated by a gap, the gap being suitable for housing an informational insert.

10. The table stand of claim 8, wherein the back of the stand further comprises a primary see-through back surface and a secondary back surface, the primary and secondary surfaces being separated by a gap, the gap being suitable for housing an informational insert.

11. The table stand of claim 2, further comprising and informational display.

12. The table stand of claim 11, wherein the informational display comprises and LED display.

13. The table stand of claim 2, further comprising one or more holes to accommodate a device cord.

14. A table stand for a mobile device, the stand comprising:
an A-frame support structure having a front leg, a back leg, a top and a bottom;
the front leg further comprising a primary see-through front surface and secondary front surface, the primary and secondary front surfaces being separated by a gap, the gap being suitable for housing an informational insert;
the back leg further comprising a primary see-through back surface and a secondary back surface, the primary and secondary surfaces being separated by a gap, the gap being suitable for housing an informational insert;
one or more shelf that projects from the bottom of the support structure at approximately a right angle for a distance sufficient to support the device;
a device port connectable to a source of electricity;
one or more holes to accommodate a device cord; and
an informational display.

15. The table stand of claim 14, wherein the informational display comprises an LED.
